(19) United States
(12) Patent Application Publication
(10) Pub. No.: US 2017/0333831 A1
(43) Pub. Date: Nov. 23, 2017

(54) PROCESS FOR SEPARATING A PRODUCT GAS FROM A GASEOUS MIXTURE UTILIZING A GAS PRESSURIZED SEPARATION COLUMN AND A SYSTEM TO PERFORM THE SAME

(71) Applicant: Carbon Capture Scientific, LLC, South Park, PA (US)

(72) Inventors: Shiaoguo Chen, Venetia, PA (US); Zijiang Pan, Amherst, PA (US); Zhiwei Li, Cheswick, PA (US); Jean-Pierre Allera, Pittsburgh, PA (US); Fei Yi, South Park, PA (US); Lidong Wu, Longguanxiang (CN)

(21) Appl. No.: 15/613,567

(22) Filed: Jun. 5, 2017

Related U.S. Application Data
(63) Continuation of application No. PCT/US2015/064236, filed on Dec. 7, 2015.
(60) Provisional application No. 62/087,885, filed on Dec. 5, 2014.

(51) Int. Cl. B01D 53/14; C10K 1/00; C10K 1/14; B01D 19/00; C10L 3/10

(52) U.S. Cl. CPC B01D 53/1425; B01D 19/0036; B01D 53/1418; C10L 3/104; C10K 1/143; C10K 1/005; B01D 19/0005; B01D 53/1493; B01D 53/1475; C10L 2290/10; C10L 2290/541; B01D 2252/20478

(57) ABSTRACT

A gas pressurized separation system strips a product gas from a stream yielding a high pressure gaseous effluent containing the product gas such as may be used to capture CO₂ from coal fired post combustion flue gas capture and to purify natural gas, syngas and EOR recycle gas. The system comprises a gas pressurized stripping column allowing flow of one or more raw streams in a first direction and allowing flow of one or more high pressure gas streams in a second direction, to strip the product gas into the high pressure gas stream and yield a high pressure gaseous effluent that contains the product gas. The process can further comprise a final separation process to further purify the product gas from the GPS column. For CO₂ product, a preferred energy efficient final separation process, compound compression and refrigeration process, is also introduced.

### RELATED APPLICATIONS

This application is a continuation of International Patent Application PCT/US 2015/064236 filed Dec. 7, 2015 and which published as WO 2016/090357, which application and publication are incorporated herein by reference.

International Patent Application PCT/US 2015/064236 claims the benefit of U.S. Provisional Patent Application Ser. No. 62/087,885, filed Dec. 5, 2014 and entitled “A Gas Pressurized Separation Column and Processes to Separate Gases using the Same” which is incorporated herein by reference.

### GOVERNMENT LICENSE RIGHTS

This invention was made, in part, with government support under United States Department of Energy Award Number: DE-FE0007567 for a project of “Development of a Novel Gas Pressurized Stripping Process-Based Technology for CO₂ Capture from Post-Combustion Flue Gases” awarded by the United States Department of Energy. The United States government has certain rights in the invention.

### FIELD OF THE INVENTION

The present invention relates to gas pressurized separation columns and to processes utilizing such columns.

### BACKGROUND OF THE INVENTION

CO2 capture from utility flue gas is the most expensive step in an integrated carbon capture and sequestration (CCS) process. The current commercial state of the art of capture technology utilizes amine-based absorption technology.

A typical, conventional process 10 using an absorption column 12 is illustrated in FIG. 1. Raw flue gas 14 enters the absorption column 12 and clean flue gas 16 exits as described below. A CO₂-lean solution 18 enters into an absorption column 12 from the top and flows downward. By contacting the flue gas countercurrent, the solution absorbs most of the CO₂ in the flue gas in the absorption column 12 and produces a CO₂-rich solution exiting at 20. The CO₂-rich solution goes through pump 22 and, in line 24, goes through heat exchanger 26. After exchanging heat with the CO₂-lean solution from the bottom of the stripping column 30, or stripper, the rich solution, in line 28, enters the stripper 30 from the top and flows downwards. CO₂ in the rich solution is stripped out by water vapor flowing upward. The heat required to strip the absorbed CO₂ is entirely provided by the water vapor. Line 49 pulls water/steam from the stripper 30 to be supplied to a reboiler 46 at the bottom of the stripper 30 with associated steam line 46. The heated water vapor from the reboiler 46 is supplied to the bottom of the stripper 30 through line 50. The CO₂-lean solution in line 32 from the bottom of the stripper 30 goes through pump 34 and to the cross heat exchanger 26 through line 36. The CO₂-lean solution from the stripper 30 exits heat exchanger 26, in line 38, and is then further cooled in cooling unit 40 before it enters the absorber in line 18 and the cycle repeats. Make-up solvent (amine) may be added through line 42 into the CO₂-lean solution. The stripped CO₂ exits the stripper 30 at the top in line 52 extending through cooler 56, having return line 58, with CO₂ leaving through line 60.

A conventional absorption/stripping process is energy intensive. The heat requirement in the stripper consists of three components:

Qₜₒₜₐₗ=Q_{sensible}+Q_{reaction}+Q_{stripping} (1)

Here Q_{reaction} is the heat of reaction (also called heat of absorption), which is the same as the heat released during absorption in the absorption column; Q_{sensible} is the sensible heat, which is the heat required to heat the CO₂-rich solution from its temperature entering the stripper to the temperature of CO₂-lean solution leaving the reboiler; and Q_{stripping} is the stripping heat, that is, the heat required to generate the water vapor coming out from the top of the stripper. Each component can be calculated by the following respective equations:

$$\begin{matrix}{Q}_{Sensible} = \frac{{C}_{p} ( {T}_{lean} - {T}_{feed} )}{Δ Loading} = {H}_{Lean} - {H}_{Rich} & ( 2 ) \\ {Q}_{reaction} = Δ {H}_{reaction} & ( 3 ) \\ {Q}_{stripping} = {( \frac{{P}_{H 2 O}}{{P}_{CO 2}} )}_{Top of the stripper} \times Δ {H}_{H 2 O} & ( 4 )\end{matrix}$$

### Here,

ΔLoading is the CO₂ difference per kg in solution between lean and rich;
Cₚ is the heat capacity of the solution in kJ/kg solution;
ΔH_{reaction} and ΔH_{H2O} are the heat of reaction and heat of vaporization of water, respectively;
T_{A} and T_{S} are the absorption and stripping temperatures, respectively;
T_{Lean} and T_{feed} are the temperature of lean solution from the stripper and the temperature of the rich solution to the stripper (after cross heat exchanger);
H_{Lean} and H_{Rich} are the enthalpy of the lean solution and the rich solution;
P_{H2O} and P_{CO2} are the partial pressures of water and CO₂ respectively; and
R is the gas constant.

When monoethanolamine (MEA) is used as solvent, the Q_{sensible}, Q_{reaction}, and Q_{stripping} for the amine-based absorption processes are roughly 480, 800, and 270 Btu/lb CO₂ respectively, with a total of around 1550 Btu/lb CO₂.

There are several fundamental disadvantages to the conventional stripping processes, including, one that the operating pressure of the stripper is determined by vapor pressure of the CO₂-lean solution in the reboiler, which in turn is determined by composition of lean solution and the reboiler temperature. In order to increase the operating pressure the temperature in the reboiler has to be raised, which is often limited by the stability of the amine solvents. The reboiler temperature in a conventional stripper is typically at 120° C. and the operating pressure is thus limited at around 28 psia.

Secondly the heat required for CO₂ stripping is entirely provided by water vapor generated in the reboiler. Thus, water vapor is used not only as stripping gas but also as a heat carrier. Due to the dual functions of steam P_{H2O} and P_{CO2} in the stripper from bottom to top are all correlated with each other. Third, due to the low operating pressure (˜28 psia) of the stripper (thus low pressure of CO₂ product), a large amount of compression work is required to compress the CO₂ product to a pipeline transportation-ready pressure (˜2250 psia).

Carbon dioxide recovery techniques are described in a variety of applications including U.S. Patent Publication No. 2002-0081256 to Chakravarti, Shrikar, et al. which discloses carbon dioxide recovery at high pressure that (A) provides a gaseous feed stream comprising carbon dioxide, wherein the pressure of said feed stream is up to 30 psia; (B) preferentially absorbs carbon dioxide from said feed stream into a liquid absorbent fluid to form a carbon dioxide enriched liquid absorbent stream; (C) in any sequence or simultaneously, pressurizes said carbon dioxide enriched liquid absorbent stream to a pressure sufficient to enable the stream to reach the top of the stripper at a pressure of 35 psia or greater, and heating the carbon dioxide enriched liquid absorbent stream to obtain a heated carbon dioxide enriched liquid absorbent stream; and (D) strips carbon dioxide from said carbon dioxide enriched liquid absorbent stream in a stripper operating at a pressure of 35 psia or greater and recovering from said stripper a gaseous carbon dioxide product stream having a pressure of 35 psia or greater. In another aspect of this process, the stripped liquid absorbent fluid from the stripper is recycled to step (B).

U.S. Patent Publication No. 2002-0026779 to Chakravarti, Shrikar, et al. discloses a system for recovering absorbate such as carbon dioxide from an oxygen containing mixture wherein carbon dioxide is concentrated in an alkanolamine containing absorption fluid, oxygen is separated from the absorption fluid, the resulting fluid is heated, and carbon dioxide is steam stripped from the absorption fluid and recovered.

U.S. Patent Publication No. 2002-0132864 to Searle, Ronald G., discloses a method for recovering carbon dioxide from an ethylene oxide production process and using the recovered carbon dioxide as a carbon source for methanol synthesis. More specifically, carbon dioxide recovered from an ethylene oxide production process is used to produce a syngas stream. The syngas stream is then used to produce methanol.

U.S. Patent Publication No. 2004-0123737 to Filippi, Ermanno, et al. discloses a process for the separation and recovery of carbon dioxide from waste gases produced by combustible oxidation comprising the steps of feeding a flow of waste gas to a gas semipermeable material, separating a gaseous flow comprising high concentrated carbon dioxide from said flow of waste gas through said gas semipermeable material, and employing at least a portion of said gaseous flow comprising high concentrated carbon dioxide as feed raw material in an industrial production plant and/or stockpiling at least a portion of said gaseous flow comprising carbon dioxide.

U.S. Patent Publication No. 2004-0253159 to Hakka, Leo E., et al. discloses a process for recovering CO₂ from a feed gas stream comprising treating the feed gas stream with a regenerated absorbent comprising at least one tertiary amine absorbent having a pKₐ for the amino function of from about 6.5 to about 9 in the presence of an oxidation inhibitor to obtain a CO₂ rich stream and subsequently treating the CO₂ rich stream to obtain the regenerated absorbent and a CO₂ rich product stream. The feed gas stream may also include SO₂ and/or NOₓ.

U.S. Patent Publication No. 2006-0204425 to Kamijo, Takashi, et al. discloses an apparatus and a method for recovering CO₂ in which energy efficiency is intended to be improved. The apparatus for recovering CO₂ includes a flow path for returning extracted, temperature risen semi-lean solution into a regeneration tower wherein at least a part of the semi-lean solution obtained by removing a partial CO₂ from a rich solution infused in a regeneration tower from an upper part of the regeneration tower is extracted, raised its temperature by heat exchanging with a high-temperature waste gas in a gas duct of an industrial facility such as a boiler, and then returned into the regeneration tower.

U.S. Patent Publication No. 2006-0248890 to Iijima, Masaki, et al. discloses a carbon dioxide recovery system capable of suppressing reduction in turbine output at the time of regenerating an absorption liquid with carbon dioxide absorbed therein, a power generation system using the carbon dioxide recovery system, and a method for operating these systems. The carbon dioxide recovery system includes a carbon dioxide absorption tower which absorbs and removes carbon dioxide from a combustion exhaust gas of a boiler by an absorption liquid; and a regeneration tower which heats and regenerates a loaded absorption liquid with carbon dioxide absorbed therein, is characterized in that the regeneration tower is provided with plural loaded absorption liquid heating means in multiple stages, which heat the loaded absorption liquid and remove carbon dioxide in the load absorption liquid, in that a turbine driven and rotated by steam of the boiler is provided with plural lines which extract plural kinds of steam with different pressures from the turbine and which supply the plural kinds of steam to the plural loaded absorption liquid heating means as their heating sources, and in that the plural lines are connected to make the pressure of supplied steam increased from a preceding stage of the plural loaded absorption liquid heating means to a post stage of the plural loaded absorption liquid heating means.

U.S. Patent Publication No. 2007-0148068 to Burgers, Kenneth L, et al. discloses an alkanolamine absorbent solution useful in recovering carbon dioxide from feed gas streams which is reclaimed by subjecting it to vaporization in two or more stages under decreasing pressures.

U.S. Patent Publication No. 2007-0148069 to Chakravarti, Shrikar, et al. discloses a system in which carbon dioxide is recovered in concentrated form from a gas feed stream also containing oxygen by absorbing carbon dioxide and oxygen into an amine solution that also contains another organic component, removing oxygen, and recovering carbon dioxide from the absorbent.

U.S. Patent Publication No. 2007-0283813 to Iijima, Masaki, et al. discloses a CO₂ recovery system which includes an absorption tower and a regeneration tower. CO₂ rich solution is produced in the absorption tower by absorbing CO₂ from CO₂ containing gas. The CO₂ rich solution is conveyed to the regeneration tower where lean solution is produced from the rich solution by removing CO₂. A regeneration heater heats lean solution that accumulates near a bottom portion of the regeneration tower with saturated steam thereby producing steam condensate from the saturated steam. A steam-condensate heat exchanger heats the rich solution conveyed from the absorption tower to the regeneration tower with the steam condensate. See also U.S. Patent Publication Nos. 2008-0056972; 2008-0223215; and 2009-0193970 to Iijima, Masaki, et al.

U.S. Patent Publication No. 2008-0016868 to Ochs, Thomas L., et al. discloses a method of reducing pollutants exhausted into the atmosphere from the combustion of fossil fuels. The disclosed process removes nitrogen from air for combustion, separates the solid combustion products from the gases and vapors and can capture the entire vapor/gas stream for sequestration leaving near-zero emissions.

U.S. Patent Publication No. 2008-0072752 to Kumar, Ravi discloses a vacuum pressure swing adsorption (VPSA) processes and apparatus to recover carbon dioxide having an alleged purity of approximately 90 mole % from streams containing at least carbon dioxide and hydrogen (e.g., syngas). The feed to the carbon dioxide VPSA unit can be at super ambient pressure. The carbon dioxide VPSA unit produces three streams, a hydrogen-enriched stream, a hydrogen-depleted stream and a carbon dioxide product stream. The recovered carbon dioxide can be further upgraded, sequestered or used in applications such as enhanced oil recovery (EOR).

U.S. Patent Publication No. 2008-0159937 to Ouimet, Michel a., et al. discloses a Carbon Dioxide capture process conducted using substantially reduced energy input using selected amines,

U.S. Patent Publication No. 2008-0286189 to Find, Rasmus, et al. discloses a method for recovery of high purity carbon dioxide, which is substantially free of nitrogen oxides. This reference also discloses a plant for recovery of said high purity carbon dioxide comprising an absorption column, a flash column, a stripper column, and a purification unit.

U.S. Patent Publication No. 2009-0202410 to Kawatra, Surendra K., et al. discloses a process for the capture and sequestration of carbon dioxide that is accomplished by reacting carbon dioxide in flue gas with an alkali metal carbonate, or a metal oxide, particularly containing an alkaline earth metal or iron, to form a carbonate salt. A preferred carbonate for CO₂ capture is a dilute aqueous solution of additive-free (NA₂ CO₃). Other carbonates include (K₂ CO₃) or other metal ion that can produce both a carbonate and a bicarbonate salt.

U.S. Patent Publication No. 2009-0211447 to Lichtfers, Ute, et al. discloses a process for the recovery of carbon dioxide, which includes: (a) an absorption step of bringing a carbon dioxide-containing gaseous feed stream into gas-liquid contact with an absorbing fluid, whereby at least a portion of the carbon dioxide present in the gaseous stream is absorbed into the absorbing fluid to produce (i) a refined gaseous stream having a reduced carbon dioxide content and (ii) an carbon dioxide-rich absorbing fluid; and (b) a regeneration step of treating the carbon dioxide-rich absorbing fluid at a pressure of greater than 3 bar (absolute pressure) so as to liberate carbon dioxide and regenerate a carbon dioxide-lean absorbing fluid which is recycled for use in the absorption step, in which the absorbing fluid is an aqueous amine solution containing a tertiary aliphatic alkanol amine and an effective amount of a carbon dioxide absorption promoter, the tertiary aliphatic alkanol amine showing little decomposition under specified conditions of temperature and pressure under co-existence with carbon dioxide.

U.S. Patent Publication No. 2009-0235822 to Anand, Ashok K., et al discloses a CO₂ system having an acid gas removal system to selectively remove CO₂ from shifted syngas, the acid gas removal system including at least one stage, e.g. a flash tank, for CO₂ removal from an input stream of dissolved carbon dioxide in physical solvent, the method of recovering CO₂ in the acid gas removal system including: elevating a pressure of the stream of dissolved carbon dioxide in physical solvent; and elevating the temperature of the pressurized stream upstream of at least one CO₂ removal stage.

U.S. Patent Publication No. 2010-0005966 to Wibberley, Louis discloses a CO₂ capture method in which at an absorber station, CO₂ is absorbed from a gas stream into a suitable solvent whereby to convert the solvent into a CO₂-enriched medium, which is conveyed to a desorber station, typically nearer to a solar energy field than to the absorber station. Working fluid, heated in the solar energy field by insulation, is employed to effect desorption of CO₂ from the CO₂-enriched medium, whereby to produce separate CO₂ and regenerated solvent streams. The regenerated solvent stream is recycled to the absorber station. The CO₂-enriched medium and/or the regenerated solvent stream may be selectively accumulated so as to respectively optimize the timing and rate of absorption and desorption of CO₂ and/or to provide storage of solar energy.

U.S. Patent Publication No. 2010-0024476 to Shah, Minish M., et al discloses a carbon dioxide recovery process in which carbon dioxide-containing gas such as flue gas and a carbon dioxide-rich stream are compressed and the combined streams are then treated to desorb moisture onto adsorbent beds and then subjected to sub-ambient temperature processing to produce a carbon dioxide product stream and a vent stream. The vent stream is treated to produce a carbon dioxide-depleted stream which can be used to desorb moisture from the beds, and a carbon dioxide-rich stream which is combined with the carbon dioxide-containing gas.

U.S. Patent Publication No. 2010-00037521 to Vakil, Tarun D., et al discloses a new steam reformer unit design, a hydrogen PSA unit design, a hydrogen/nitrogen enrichment unit design, and processing scheme application. The discussed result of these innovations allegedly results in re-allocating most of the total hydrogen plant CO₂ emissions load to high pressure syngas stream exiting the water gas shift reactor while minimizing the CO₂ emissions load from the reformer furnace flue gas.

The above identified patent publications are helpful for identifying certain concepts known in the art and are incorporated herein by reference.

It would be desirable to develop a separation system and separation processes that overcome issues of the prior art systems and reduce the energy consumption of a separation process significantly.

The applicant previously addressed these issues in a related invention disclosed in U.S. Patent Publication 2014-0017622, WO 2012-006610 and U.S. Pat. No. 8,425,655, which publications and patents are incorporated herein by reference. This prior development was drawn to a gas pressurized separation (GPS) system or a process to strip a product gas from a liquid stream and yield a high pressure gaseous effluent containing the product gas. The system comprises a gas pressurized stripping apparatus, such as a column, with at least one first inlet allowing flow of one or more liquid streams into the apparatus, generally in a first direction, and at least one second inlet allowing flow of one or more high pressure gas streams into the apparatus, generally in a second direction, to strip the product gas into the high pressure gas stream and yield through at least one outlet a high pressure gaseous effluent that contains the product gas. The system further comprises two or more heat supplying apparatuses provided at different locations along the column for allowing for independent control of the temperature along the stripping apparatus or column.

Also provided in the previously related inventions is a process for separating a product gas from a gaseous mixture to yield a high pressure gaseous effluent in which the product gas has a partial pressure generally at least 10 times higher than in the gaseous mixture, the process comprising: (a) introducing the gaseous mixture into contact with a liquid flowing in an absorption apparatus, to absorb the product gas into the liquid and yield a product-enriched liquid; (b) introducing the product-enriched liquid into at least one inlet of a gas pressurized column and into contact with one or more high pressure gas streams to strip the product gas into the high pressure gas stream and to yield a product-lean liquid and one or more high pressure gaseous effluents enriched with the product gas, wherein the product gas has a partial pressure higher than in the gaseous mixture; (c) recovering heat from the product-lean liquid; and (d) recycling at least a portion of the product-lean liquid to step (a).

The process in previously related invention of the applicants further comprises after step (a), and before step (b), (i) introducing at least a portion of the product-enriched liquid from the absorption apparatus in step (a) into at least one additional absorption apparatus and into contact with a gas stream that comprises at least a portion of the gaseous effluent from the gas pressurized column in step (b), to absorb the product gas into the product-enriched liquid and yield a further product-enriched liquid; and (ii) subsequently introducing the further product-enriched liquid from the additional absorption apparatus into at least one flasher to recover a portion of the product gas prior to introduction of the product-enriched liquid into the gas pressurized column in step (b).

Comparing to the conventional process, it is believed that the process in previously related invention of the applicants introduced above can reduce the energy requirement in the stripping column and produce a high pressure, pure product gas stream, which will greatly reduce subsequent compression work. From continued research, however, the inventors have discovered that two or more heating apparatus in the GPS stripping column may not be absolutely necessary and an improved configuration of GPS column and its application processes as described subsequently can be configured. The new invented process will not only further reduce the energy requirement but also the process capital cost due to the simplification of the process.

### SUMMARY OF THE INVENTION

The present invention is drawn to a gas pressurized separation system to strip a product gas from a liquid stream and yield a high pressure gaseous effluent containing the product gas. The improved invention is still based on the previously related invention gas pressurized separation system or a process to strip a product gas from a liquid stream and yield a high pressure gaseous effluent containing the product gas, disclosed in U.S. Patent Publication 2014-0017622, WO 2012-006610 and U.S. Pat. No. 8,425,655, which are incorporated herein by reference. In the present embodiment there need only be one or more heating apparatuses in the GPS system of the invention for controlling the temperature in the GPS system.

The present embodiments of the invention do not require, although it is possible to incorporate such additional equipment, an additional absorption apparatus for separating a product gas from a gas mixture, which modifications simplify the process and reduce capital cost.

A process according to the present invention for separating a product gas from a gaseous mixture to yield a high pressure gaseous effluent in which the product gas has a partial pressure generally at least 4 times higher than in the gaseous mixture comprises: (a) introducing the gaseous mixture into contact with a liquid flowing in an absorption apparatus, to absorb the product gas into the liquid and yield a product-enriched liquid; (b) introducing the product-enriched liquid into at least one inlet of a gas pressurized stripping column and into contact with one or more high pressure gas streams to strip the product gas into the high pressure gas stream and to yield a product-lean liquid and one or more high pressure gaseous effluents enriched with the product gas, wherein the product gas has a partial pressure higher than that in the gaseous mixture; (c) introducing the product-enriched liquid into at least one high pressure flasher between (a) and (b) wherein each flasher produces a stream enriched with the product gas prior to introducing the product-enriched liquid into the gas pressurized stripping column; (d) recovering heat from the product-lean liquid; and (e) recycling at least a portion of the product-lean liquid to step (a).

It is believed that the improved process can reduce the energy requirement in the stripping column and produce a high pressure product gas stream, which will reduce subsequent compression work. The present invention is described in greater detail in the following description of the present invention wherein like elements are given like reference numerals throughout.

### BRIEF DESCRIPTION OF THE DRAWINGS

FIG. 1 is a schematic diagram of a conventional prior art absorption process for CO₂ separation;

FIG. 2 is a schematic diagram of one embodiment of the process of the present invention using aqueous amine as solvent to separate a product gas from a gas mixture;

FIG. 3 is an exemplary schematic diagram of a separation process of one embodiment of the present invention using physical solvent to separate product gas from high pressure raw gas;

FIG. 4 is an exemplary schematic diagram of a separation process of one embodiment of the present invention using nitrogen as a high pressure gas stream and aqueous amine as solvent to separate carbon dioxide from post-combustion flue gas followed by compression-refrigeration process as a final separation process; and

FIG. 5 is an exemplary schematic diagram of a compound compression refrigeration separation process.

### DETAILED DESCRIPTION OF THE INVENTION

A gas pressurized separation (GPS) system and associated processes to strip a product gas from a liquid stream and yield a high pressure gaseous effluent containing the product gas are disclosed in related U.S. Patent Publication 2014-0017622, WO 2012-006610 and U.S. Pat. No. 8,425,655, which are incorporated herein by reference. The GPS system in the previously related invention is always a core component in any application introduced in the improved invention. The modification in the present embodiment to the setting of original GPS system includes the number of the heat supplying apparatus necessary to be integrated to the GPS system. The greater the number of the heat supplying apparatuses in the column is; the better the potential thermodynamic efficiency of the separation process will be. However, the complexity of the GPS column and thus the capital costs of the column as well as the operating cost of the GPS system increases with the number of heat supply apparatus. Therefore, instead of using at least two heat supplying apparatus, the simplified processes of the present invention provide one or more heat supplying apparatus can be positioned in one or different location(s) along the column. The modified setting is applicable to either tray-type separation column or packed-type separation column and to either internal heating or external heating apparatus to the column.

The previously related invention disclosed an application/process which uses an additional absorption apparatus to absorb the product gas from at least a portion of the gaseous effluent from the gas pressurized column with at least a portion of the product-enriched liquid from the absorption apparatus to yield a further product-enriched liquid. Moreover, at least one flasher is used to recover a portion of the high pressure product gas from the further product-enriched liquid prior to introduction of the product-enriched liquid into the gas pressurized column. For the present invention embodiments, however, the additional absorption apparatus need not be employed anymore in any applications of GPS system for separating a product gas from a gas mixture to simplify the process and reduce capital cost.

A process in the present invention for separating a product gas from a gaseous mixture to yield a high pressure gaseous effluent in which the product gas has a partial pressure generally at least 4 times higher than in the gaseous mixture comprises: (a) introducing the gaseous mixture into contact with a liquid flowing in an absorption apparatus, to absorb the product gas into the liquid and yield a product-enriched liquid; (b) introducing the product-enriched liquid into at least one inlet of a gas pressurized stripping (GPS) column and into contact with one or more high pressure gas streams to strip the product gas into the high pressure gas stream and to yield a product-lean liquid and one or more high pressure gaseous effluents enriched with the product gas, wherein the product gas has a partial pressure higher than that in the gaseous mixture; (c) introducing the product-enriched liquid into at least one high pressure flasher between (a) and (b) wherein each flasher produces a stream enriched with the product gas prior to introducing the product-enriched liquid into the gas pressurized stripping column; (d) recovering heat from the product-lean liquid; and (e) recycling at least a portion of the product-lean liquid to step (a).

The process of the improved invention will be described below using carbon dioxide as the desired product gas. Often carbon dioxide is present in natural gas, syngas or combustion flue gases from a carbonaceous fuel burning facility. This is for illustrative purposes only and is in no way intended to limit the invention.

In a preferred embodiment, the primary separation steps are arranged as follows: absorption/flasher(s)/gas pressurized stripping. This process sequence provides a significant energy savings over conventional separation processes. In this preferred process, for example, the CO2-rich solution leaving the absorption column can go through one or more flashers (depending the CO2 loading in the rich solutions) to produce high pressure pure CO2. The new product-enriched liquid (a semi-rich solution) after passing through the flashers, then enters the GPS column to strip out the remaining CO2 to restore the specific lean CO2 concentration for absorption after being recycled to the absorber. In the GPS column a pressurized gas stream is introduced from the bottom to strip the CO2 out from the semi-rich solution. The pressurized gas could be any pure gas or mixtures of any gases as long as it is not harmful and will not condense in the system. Along with the high pressure stripping gas (or gas mixture), one or more heat supplying apparatuses are also provided to the GPS column to deliver heat needed for the stripping process. The gaseous effluent from top of the GPS column is a CO2-riched product gas containing small amount of stripping gas. Depending on the requirement of the product gas, the CO2-riched product gas containing small amount of stripping gas could be directly used as product or it can be further condensed, compressed and dehydrated to form final CO₂ product as specified. This process can separates at least 90% mol of CO₂ from the raw gas depending on the applications and the CO₂ purity in the final product can vary depending on the subsequent applications of the CO₂ product. Depending on the operating conditions, 99% mol (dry base) purity can be achieved.

The stripping gas stream may be any gases that are not harmful to system/solvents in the liquid, will not condense and will not interfere with the stripping system. Inorganic gases such as He, Ar, O2, N2, air, and their mixtures or organic gases such as CH4, C2H6, C3H8, C2H4 and their mixtures or any mixtures of organic and inorganic gases can all be used as stripping gas. In some applications the combination of methane, ethane, propane, butane, pentane and mixtures thereof represent an effective class of available stripping gasses. The high pressure stripping gas stream may comprise a single pure gas selected from the group of He, Ar, O2, N2, CH4, C2H6, C3H8, C2H4, C4H10, and C5H12. Alternatively the high pressure gas stream may comprise a mixture of different gases selected from a mixture of gas selected from the group of He, Ar, O2, N2, air, CH4, C2H6, C3H8, C2H4 C4H10, and C5H12. The high pressure gas stream may contain carbon dioxide and may be selected from the group of nitrogen, methane, ethane, propane, purified syngas, natural gas, and CO₂ EOR recycled gas. There are virtually unlimited options for the stripping gases. The stripping gases are usually introduced into the GPS column from the bottom and may contain a small amount of carbon dioxide as well. The usage of the selected stripping gas is determined by purity requirement of CO₂ product. The pressure of the selected stripping gas is determined by the desired CO2 loading in the lean solution leaving the GPS column.

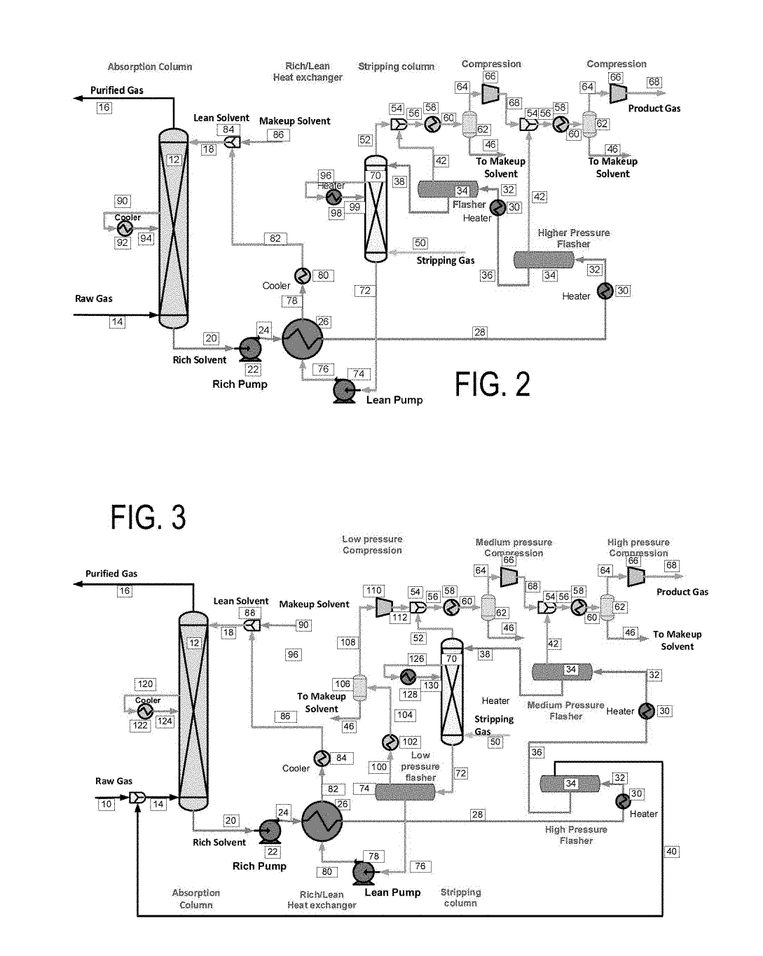

FIG. 2 is a schematic diagram for one system implementing the process sequences absorption/flasher(s)/pressurized gas stripping. Raw gas 14 enters the bottom of the absorption column 12 and clean gas 16 exits the top of the column 12 while a CO2-lean solution 18 enters into the absorption column 12 from the top and flows downward producing a CO2-rich solution exiting at the bottom in line 20.

The CO2-rich solution is directed through pump 22, line 24, heat exchanger 26 and heater 30, and enters a high pressure flasher 34 (or a series of flashers with pressure from high to low) to flash high pressure CO2 out through line 42. The semi-rich solution (product-enriched liquid) from the bottom of the flasher 34 (or the last flasher if there is more than one flasher) is directed through line 38 and then enters the GPS column 70 from the top. The high pressure stripping gas stream in line 50 enters the bottom of the GPS column 70 and strips the CO2 from the semi-rich solution (product-enriched liquid) flowing countercurrent.

The CO2-lean solution is directed via line 72 from the column 70 through pump 74 to heat exchanger 26 to cooler 80 and to line 82 wherein make-up solvent (amine and water) may be added through line 86 into the lean solution through a mixer 84 before it enters the absorber in line 18 and the cycle repeats. The gaseous effluent 52 from the GPS column 70 mixes with gaseous effluent in line 42 from the last flasher through mixer 54 and then is cooled in cooling unit 58 and supplied by line 60 to liquid gas separator 62 with liquid or water exiting at line 46 used as makeup solvent and gas exiting at line 64. The gas in line 64 is compressed in compressor 66 to a specific pressure for the product gas at line 68. Multi-stage high pressure flashers can be used for the high product-enriched solution with the gaseous effluent 42 combining with the corresponding pressure product rich gas from line 68 and repeating the cooling 58, gas-liquid separation 62 and compression 66 process.

Multi-stage compression with inter-stage cooling can be used for the product gas wherever required. For better mass transfer efficiency, one or more heat supplying apparatus can be installed to GPS column 70 as side heating devices. Similarly, one or more cooling apparatus can be installed associated with the absorption column 12.

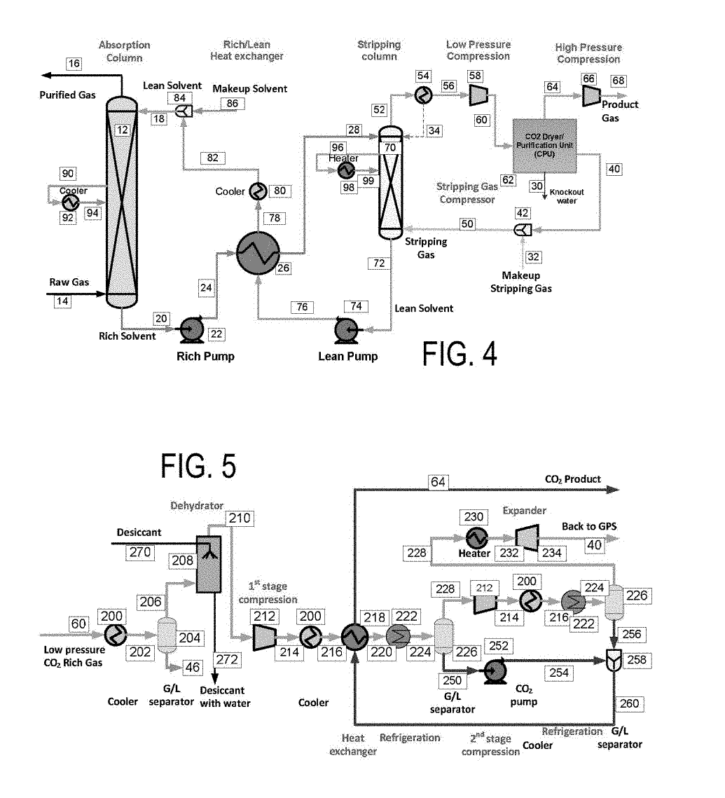

The process depicted in FIG. 2 can be used for purifying various raw gas under various pressure. Minor modification can be applied to the process to optimize for different raw gas streams. For example, the process may be used to capture CO₂ from post combustion flue gas. Flue gas emits from fossil fuel combustion as exhaust gases from furnaces, boilers or steam generators. Flue gas composition depends on what is being burned but it usually consists of mostly nitrogen derived from the combustion air, carbon dioxide and water vapor as well as excess oxygen after pollution control. Minimal or even no flashers may be required in the process owing to the rich CO₂ loading is not sufficiently high. Instead, with no flashers as shown in FIG. 4, the rich solution is directed to the GPS column 70 from the heat exchanger 26. Moreover, the operating pressure in the GPS column is possibly much higher (e.g. at least 4 atm) than that in the absorption column (atmospheric pressure). The process depicted in FIG. 4 can separate at least 90% of CO₂ from the raw gas at a desired CO₂ purity in the final product and depending on the operating conditions a 99% purity can be achieved, if required. Table 1 illustrates an example when the process of FIG. 2 with the flashers omitted is applied for CO₂ capture from flue gas which includes flows, conditions, energy requirements and composition of flue gas, clean flue gas, stripping gas and CO₂ product streams.

TABLE 1
An example of the invention application
to CO₂ capture from flue gas

| | Raw | Clean | | |
|---|---|---|---|---|
| | flue | flue | Stripping | CO₂ |
| Parameters | gas | gas | gas | product |
| Flow rate, kmol/hr | 109,300 | 81,930 | 395 | 13457 |
| Pressure, bar | 1.03 | 1.01 | 6 | 153 |
| Compositions, mol % | | | | |
| CO₂ | 13.26 | 1.73 | 0 | 96.86 |
| N₂ | 67.71 | 90.35 | 100 | 2.89 |
| H₂O | 16.68 | 4.77 | 0 | 0.25 |
| O₂ | 2.35 | 3.14 | 0 | 0 |

| | |
|---|---|
| Energy demand, MW | |
| Heat | 306 |
| Power | 41 |
| Number of flashers | 0 |

The process depicted in FIG. 2 can be used to purify raw gas mixture under pressure (2 atm and above), which includes but not limits to natural gas, syngas and CO₂ enhanced oil recovery (EOR) recycle gases. The operating configuration of the process can be adjusted to accommodate the condition of raw gas (i.e. raw gas pressure and CO₂ content) for better energy performance. For example, the operating pressure for both absorption and GPS column are preferred to set to be the same or close each other to reduce the power consumption in pumping the circulation solvent when the raw gas pressure is high, such as 4 atm and above; one or more flashers are preferred in the process to obtain the high pressure CO₂ product to reduce subsequent compression power. Moreover, the process depicted in FIG. 2 can separate at least 90% mol of CO₂ from the raw gas at a desired CO₂ purity in the final product (depending on the operating conditions a 99% purity (dry base) can be achieved if required.

Natural gas is a hydrocarbon gas mixture consisting primarily of methane, but commonly includes varying amounts of other higher alkanes and even a lesser percentage of carbon dioxide, nitrogen, and hydrogen sulfide. Natural gas is an energy source often used for heating, cooking, and electricity generation. It is also used as fuel for vehicles and as a chemical feedstock in the manufacture of plastics and other commercially important organic chemicals. Table 2 illustrates an example when the process of FIG. 2 with only a single flasher is applied for natural gas purification which includes flowrates, conditions, energy requirements and composition of flue gas, purified natural gas, stripping gas and CO₂ product streams.

TABLE 2
An example of the invention application to natural gas purification

| | Raw | Clean | | |
|---|---|---|---|---|
| | natural | natural | Stripping | CO₂ |
| Parameters | gas | gas | gas | product |
| Flow rate, kmol/hr | 4,823 | 3,795 | 57 | 1,093 |
| Pressure, bar | 63 | 63 | 63 | 153 |
| Compositions, mol % | | | | |
| CO₂ | 23.69 | 2.84 | 2.84 | 95.13 |
| N₂ | 3.03 | 3.85 | 3.85 | 0.20 |
| H₂O | 0.03 | 0.10 | 0.10 | 0.18 |
| CH₄ | 71.99 | 91.61 | 91.61 | 4.42 |
| C₂H₆ | 1.07 | 1.36 | 1.36 | 0.06 |
| C₃H₈+ | 0.19 | 0.24 | 0.24 | 0.01 |

| | |
|---|---|
| Energy demand, MW | |
| Heat | 19.1 |
| Power | 0.7 |
| Number of flashers | 1 |

Syngas is a fuel gas mixture consisting primarily of hydrogen, carbon monoxide, and carbon dioxide. Syngas is usually a product of fossil fuel gasification and the main application is electricity generation. Syngas is also used as intermediates in creating synthetic natural gas and for producing ammonia or methanol. Syngas is combustible and often used as a fuel of internal combustion engines. Table 3 illustrates an example when the process of FIG. 2 with only a single flasher is applied for syngas purification which includes flowrates, conditions, energy requirements and composition of flue gas, purified syngas, stripping gas and CO₂ product streams.

TABLE 3
An example of the invention application to syngas purification

| | Raw | Clean | Stripping | CO₂ |
|---|---|---|---|---|
| Parameters | syngas | syngas | gas | product |
| Flow rate, kmol/hr | 4,823 | 3,320 | 75 | 1,579 |
| Pressure, bar | 75 | 75 | 75 | 153 |
| Compositions, mol % | | | | |
| CO₂ | 33.15 | 2.78 | 0 | 95.06 |
| N₂ | 0.38 | 0.70 | 100 | 4.43 |
| H₂O | 0.00 | 0.09 | 0 | 0.19 |
| CH₄ | 0.44 | 0.64 | 0 | 0.00 |
| H₂ | 64.53 | 93.62 | 0 | 0.32 |
| CO | 1.5 | 2.18 | 0 | 0.01 |

| | |
|---|---|
| Energy demand, MW | |
| Heat | 25.4 |
| Power | 0.7 |
| Number of flashers | 1 |

Enhanced Oil Recovery, EOR, is a technique for increasing the amount of crude oil that can be extracted from an oil field. CO₂ injection is presently the most commonly used EOR approach. Gaseous stream in crude oil, mostly CO₂ and small percentage of natural gas, is CO₂ EOR recycle gas, which is usually separated to recover natural gas and produce CO₂ for recycling back to the EOR process. Table 4 illustrates an example when the process of FIG. 2 (with three flashers in series) is applied for CO₂ EOR recycle gas separation. Table 4 includes flowrates, conditions, energy requirements and composition of CO₂ EOR recycle gas, recovered natural gas, stripping gas and CO₂ product streams.

TABLE 4
An example of the invention application
to CO₂ EOR recycle gas separation

| | Raw | Recovered | Stripping | CO₂ |
|---|---|---|---|---|
| Parameters | gas | gas | gas | product |
| Flow rate, kmol/hr | 5,787 | 583 | 275 | 5,464 |
| Pressure, bar | 14.8 | 14.8 | 30 | 153 |
| Compositions, mol % | | | | |
| CO₂ | 91.87 | 22.67 | 0 | 95.17 |
| N₂ | 0.88 | 8.74 | 0 | 0.00 |
| H₂O | 0.00 | | 0 | 0.20 |
| H₂S | 0.91 | 0.00 | 0 | 0.17 |
| CH₄ | 1.51 | 20.29 | 100 | 4.46 |
| C₂H₆ | 1.35 | 13.40 | 0 | 0.00 |
| C₃H₈ | 1.60 | 15.88 | 0 | 0.00 |
| C₄H₁₀+ | 1.88 | 19.02 | 0 | 0.00 |

| | |
|---|---|
| Energy demand, MW | |
| Heat | 86.18 |
| Power | 8.73 |
| Number of flashers | 3 |

FIG. 2 is illustrated for an aqueous alkanolamines solvent system. However, the GPS technology can be also applicable to physical solvent. FIG. 3 is an example of a system using physical solvent to purify a raw syngas. In system the details of the absorption column 12 and GPS column 70 are described above. The primary differences from the process depicted in FIG. 2 are: 1) the gaseous effluent from the first high pressure flasher after heat exchanger 26 is returned back to combine with raw syngas to enter the absorption column to reduce the loss of hydrogen product; 2) a low pressure flasher is applied to the lean solution exited from bottom of the GPS column 70 to restore CO₂ content in the lean solvent to specified concentration; 3) the operating pressure in the GPS column is much lower than that in the absorption column. The process depicted in FIG. 3 separates at least 90% mol of CO₂ from the raw gas with the CO₂ purity in the final product is at least 95% mol (dry base).

Unlike amine based acid gas removal solvents that rely on a chemical reaction with the acid gases, physical solvent absorb acid gas without chemical reaction involved. As a result, physical solvent usually requires less energy than the amine based processes. However, physical solvent only applies to high pressure feed gas because its working capacity is reduced when the feed gas pressures is below about 300 psia (20.7 bar). Physical solvent is made up of dimethyl ethers of polyethylene glycol. Physical solvent is commercially available such as DMPEG/Selexol, Purisol or Rectisol. Table 5 illustrates an example when the process of FIG. 3 is applied for syngas purification. Table 5 includes flowrates, conditions, energy requirements and composition of syngas, Purified syngas, stripping gas and CO₂ product streams.

TABLE 5
An example of the invention application to
syngas purification with physical solvent

| | Raw | Clean | Stripping | CO₂ |
|---|---|---|---|---|
| Parameters | syngas | syngas | gas | product |
| Flow rate, kmol/hr | 4,823 | 3,321 | 75 | 1,570 |
| Pressure, bar | 75 | 75 | 83 | 153 |
| Compositions, mol % | | | | |
| CO₂ | 33.15 | 2.75 | 0 | 95.05 |
| N₂ | 0.38 | 1.09 | 100 | 4.15 |
| H₂O | 0.00 | 0.00 | 0 | 0.00 |
| CH₄ | 0.44 | 0.62 | 0 | 0.03 |
| H₂ | 64.53 | 93.39 | 0 | 0.72 |
| CO | 1.50 | 2.15 | 0 | 0.05 |

| | |
|---|---|
| Energy demand, MW | |
| Heat | 18.55 |
| Power | 4.86 |
| Number of flashers | 3 |

In certain embodiments of the improved invention, the process further comprises after step (b) subjecting the high pressure gaseous effluent from the gas pressurized column to a final separation process to further purify the product gas. In principle, many separation methods could be used to separate the product gas from the gaseous effluent. For CO₂ product, for example, a preferred energy efficient final separation process is compound compression and refrigeration process which illustrated in FIG. 4. The primary advantage of the compression/refrigeration process is elevating the pressure of gas effluent from the GPS column to reduce compression work and stripping heat. Moreover, this process produces high purity CO₂ product (its purity is at least 99% mol).

FIG. 4 does not depict any refrigeration systems that are required for this compound separation process. However, such a design is evident to one skilled in the art. Specifically in FIG. 4, as the CO₂ rich solution enters column 70 at the top in line 28 and lean solution exits the bottom in line 72. Stripping gas, N2, enters column 70 at 50 and exits in line 52 at the top of column 70. The high-pressure CO₂ and N2 mixture from the GPS column is further separated and compressed with a compound compression and refrigeration process, as shown in FIG. 4. Line 52 first leads to cooling unit and a first phase separator 54. Liquid is returned to the GPS column from the separator 54 in line 34 and gaseous stream exits in line 56. The Gaseous stream in line 56 is then compressed to about 20 bar through low pressure compressors and then goes through a CO₂ dryer and purification unit 62.

FIG. 5 further exhibits the compound compression-refrigeration process represented unit 62 in FIG. 4. The purification unit 62 mainly comprises of a CO₂ dehydration and two-stage compound compression-cooling-refrigeration process: 20 to 40 bar and 40 to 80 bar or variations thereof can be used. The compressed gaseous stream 60 is cooled at cooler 200 to 35° C. and then goes through a liquid-gas separator 204 to remove condensed water through stream 46.

The gaseous stream 206 from separator 204 enters the bottom of a dehydrator 208 and contact with desiccant to further remove water in the gaseous stream. The dehydrated gaseous stream 210 is then compressed to 40 bar at the first stage compression 212. The compressed gaseous stream 214 is cooled to 35° C. first at cooler 200 and further cooled by the liquefied CO₂ product through a cross heat exchanger 218.

Next, the gaseous stream 220 is further cooled to −5° C. by refrigeration 222 to liquefy the majority of CO₂ from the stream 220. The liquefied CO₂ in stream 224 is separated by a gas-liquid separator 226 through stream 250. The gaseous stream 228 from separator 226 is further compressed to 80 bar through the second stage compression 212. The further compressed gaseous stream 212 is cooled to 35° C. first at cooler 200 and then is further cooled up to −20° C. by refrigeration 222 to further liquefy CO₂. The liquefied CO₂ in stream 224 is removed by a gas-liquid separator 226 through stream 256. The N2 concentration in remaining gaseous stream 228 is sufficiently high to meet stripping gas specifications.

The remaining gaseous stream 228 enters three stages of expansion 234 with inter-stage heating 230 to recover power in the high pressure gaseous stream 228. The expansion cycles used were 80-40 bar, 40-20 bar, and 20-10 or 8 bar. Finally, the remaining gas stream 40 (at 8-10 bar) is recycled to the GPS column for use as a stripping gas after mixed with make-up stripping gas stream 32. The liquefied CO₂ stream 250 is pumped to 80 bar and then merged with liquefied CO₂ stream 256 to for CO₂ product stream 260 with CO₂ purity over 99.5%. The refrigeration heat in the liquefied CO₂ product is recovered through heat exchangers 218 to 30° C.

The refrigeration heat is provided by any refrigeration process. For example, ammonia can be used in a compression-expansion circulation. Refrigeration heat is generated by expanding high-pressure ammonia gas to low-pressure to obtain a low-temperature gas-liquid mixture. The temperature of the mixture can be controlled by adjusting the expander outlet pressure.

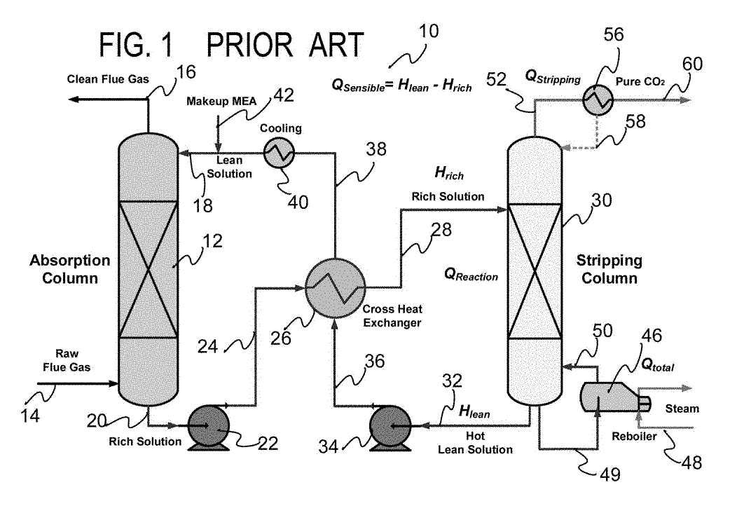

In the representative FIGS. 1-5 of this application not all blowers or pumps or valves are illustrated as the use of these are well known to those of ordinary skill in the art. Only a representative sample of these elements are specifically illustrated in the figures to evidence their presence in an operational system. Additionally not shown are the controllers and system sensors used for operating similar systems, but these are also known to those of ordinary skill in the art.

The process of the present invention has numerous applications, as discussed above, such as where the product gas is CO₂ and where the gaseous mixture is coal fired post-combustion flue gas, and in which, typically, the operating pressure in the gas pressurized stripping column will be at least 4 atm. Alternatively, the process of invention may be utilized where the gaseous mixture is a raw gas, such as syngas or natural gas, under pressure, and where the operating pressure in the gas pressurized stripping column is similar to the operating pressure in absorption column, wherein the liquid is an aqueous alkanolamine.

The process of the present invention has numerous applications with distinct operating parameters, as discussed above, such as, where the gaseous mixture is natural gas and the product gas comprises carbon dioxide, the high pressure gas stream is at least 60 Bar within the high pressure stripping column. Alternatively, where the gaseous mixture is syngas and the product gas comprises carbon dioxide, the high pressure gas stream is at least 75 Bar within the high pressure stripping column. Further, where the gaseous mixture is CO₂ EOR recycled gas, and the product gas comprises carbon dioxide, the high pressure gas stream is at least 30 Bar within the high pressure stripping column.

The above description and associated figures are intended to be illustrative of the present invention and not be restrictive thereof. A number of variations may be made to the present invention without departing from the spirit and scope thereof. The scope of the present invention is defined by the appended claims and equivalents thereto.

What is claimed is:

1. A process for separating a product gas from a gaseous mixture to yield a high pressure gaseous effluent in which the product gas has a partial pressure at least 4 times higher than in the gaseous mixture, comprising:
(a) introducing the gaseous mixture into contact with at least one liquid in an absorption apparatus, to absorb the product gas into the liquid and yield at least one product-enriched liquid;
(b) introducing the product-enriched liquid into at least one inlet of a gas pressurized column and into contact with at least one high pressure gas streams to strip the product gas into the high pressure gas stream and to yield at least one product-lean liquid and at least one high pressure gaseous effluents enriched with the product gas;
(c) introducing the product-enriched liquid into at least one flasher between steps (a) and (b), wherein each flasher produces a stream enriched with the product gas prior to introducing the product-enriched liquid into the gas pressurized stripping column in step (b);
(d) recovering heat from the product-lean liquid; and
(e) recycling at least a portion of the product-lean liquid to the absorption apparatus at step (a).

2. The process of claim 1, wherein the product gas comprises carbon dioxide.

3. The process of claim 1, wherein the high pressure stripping gas stream comprises a single pure gas selected from the group of He, Ar, O2, N2, CH4, C2H6, C3H8, C2H4, C4H10, and C5H12.

4. The process of claim 1, wherein the high pressure gas stream comprises a mixture of different gases selected from a mixture of gas selected from the group of He, Ar, O2, N2, air, CH4, C2H6, C3H8, C2H4 C4H10, and C5H12.

5. The process of claim 1, wherein the high pressure gas stream contains carbon dioxide.

6. The process of claim 1, wherein the high pressure gas stream is selected from the group of nitrogen, methane, ethane, propane, purified syngas, natural gas, and CO₂ EOR recycled gas.

7. The process of claim 1, wherein the product gas is CO₂, wherein the gaseous mixture is coal fired postcombustion flue gas, and wherein the operating pressure in the gas pressurized stripping column is at least 4 atm.

8. The process of claim 1, wherein the gaseous mixture is a raw gas under pressure, and wherein the operating pressure in the gas pressurized stripping column is similar to the operating pressure in absorption column.

9. The process of claim 8 wherein the liquid is an aqueous alkanolamine.

10. The process of claim 8 wherein the raw gas is syngas.

11. The process of claim 1 further comprising after step (b) the step of subjecting the high pressure gaseous effluent from the gas pressurized stripping column to a compound compression and refrigeration process.

12. The process of claim 1, wherein the gaseous mixture is natural gas.

13. The process of claim 12, wherein the product gas comprises carbon dioxide.

14. The process of claim 13, wherein the high pressure gas stream is at least 60 Bar within the high pressure stripping column.

15. The process of claim 1, wherein the gaseous mixture is syngas.

16. The process of claim 15, wherein the product gas comprises carbon dioxide.

17. The process of claim 16, wherein the high pressure gas stream is at least 75 Bar within the high pressure stripping column.

18. The process of claim 1, wherein the gaseous mixture is CO₂ EOR recycled gas.

19. The process of claim 18, wherein the product gas comprises carbon dioxide, and wherein the high pressure gas stream is at least 30 Bar within the high pressure stripping column.

20. A gas pressurized stripping system that comprises:
(i) a gas pressurized stripping column with at least one first inlet allowing flow of one or more liquid streams in a first direction and at least one second inlet allowing flow of one or more high pressure gas streams in a second direction, to strip the product gas into the high pressure gas stream and yield through at least one outlet a high pressure gaseous effluent that contains the product gas;
(ii) heat is provided through heat supply apparatuses from one or more different locations along the column allowing for independent control of the temperature along the stripping column.
